(19) United States
(12) Patent Application Publication
(10) Pub. No.: US 2021/0341298 A1
(43) Pub. Date: Nov. 4, 2021

(54) NAVIGATION INFORMATION SHARING METHOD AND SYSTEM

(71) Applicant: BEIJING DIDI INFINITY TECHNOLOGY AND DEVELOPMENT CO., LTD., Beijing (CN)

(72) Inventor: Wei MIAO, Beijing (CN)

(73) Assignee: BEIJING DIDI INFINITY TECHNOLOGY AND DEVELOPMENT CO., LTD., Beijing (CN)

(21) Appl. No.: 17/356,561

(22) Filed: Jun. 24, 2021

Related U.S. Application Data
(63) Continuation of application No. PCT/CN2019/125748, filed on Dec. 16, 2019.

(30) Foreign Application Priority Data
Dec. 25, 2018 (CN) 201811593869.6
Dec. 25, 2018 (CN) 201811595171.8

(51) Int. Cl. G01C 21/34; G01C 21/28

(52) U.S. Cl. CPC G01C 21/3415; G01C 21/28

(57) ABSTRACT

The method and device for sharing navigation information provided in some embodiments of the present disclosure may obtain a navigation route by determining different road sections in an entire route of a user travel in a process of user travel. Each existing real-time shared navigation route that will enter the road section may be obtained, so as to realize the sharing of the navigation route. Therefore, the computation load for navigation data may be effectively reduced. The occupation and waste of computing resources may be reduced. Further, the convenience and smoothness of travel by the user terminal may be ensured, which is beneficial in improving the experience of the user terminal.

### CROSS-REFERENCE TO RELATED APPLICATIONS

This application is a Continuation of International Application No. PCT/CN2019/125748, filed on Dec. 16, 2019, which claims priority of Chinese Patent Application No. 201811595171.8, filed on Dec. 25, 2018, and Chinese Patent Application No. 201811593869.6, filed on Dec. 25, 2018, the contents of each of which are hereby incorporated by reference in its entirety.

### TECHNICAL FIELD

The present disclosure generally relates to intelligent navigation, and in particular, to a navigation information sharing method and device.

### BACKGROUND

With the continuous development of science and technology, the automobile has gradually entered people's lives and has become an indispensable travel tool for most families. Especially in recent years, concepts of intelligent travel and intelligent transportation gradually enter the public's vision. Combining with advanced technology and concepts such as mobile Internet, cloud computation, big data, Internet of Things, etc., the traditional transportation and the Internet may be effectively interpenetrated and fused to form new states and new modes with advantages such as “reasonable allocation of resources online, efficient and high-quality operation offline.”

Generally, when a user goes to a strange place, or when a route is not familiar, the user may use navigation software, etc. to generate a navigation route and travel based on the navigation route before the travelling (e.g., driving). However, with a sharp increase of the number of users, a plan of a navigation route for each user (especially during a navigation process, there is also a real-time adjustment of the navigation route with changes of road conditions) may greatly increase the computation load of a background processor and the occupation of computing resources, resulting in a lot of affordable and resource waste.

### SUMMARY

An aspect of the present disclosure relates to a method for sharing navigation information. The method may include determining, based on a road section end position of a current navigation road section and a travel end position of a first user terminal, whether there is a second user terminal that is travelling within a same time period as the first user terminal when the first user terminal is travelling on the current navigation road section. A travel plan of the second user terminal may be from the road section end position to the travel end position. The method may include obtaining a shared navigation route that the second user terminal reaches the travel end position from the road section end position in response to determining that there is a second user terminal that is travelling within the same time period as the first user terminal. The method may also include determining a first navigation road section in the shared navigation route as a next navigation road section which the first user terminal enters after the first user terminal passes through the current navigation road section. The method may further include sending navigation information of the first navigation road section in the shared navigation route to the first user terminal.

In some embodiments, after determining whether there is a second user terminal that is travelling within a same time period as the first user terminal, the method may further include obtaining a stored historical navigation route from the road section end position to the travel end position based on the road section end position of the current navigation road section and the travel end position of the first user terminal in response to determining that there is no second user terminal that is travelling within the same time period as the first user terminal. The method may include detecting whether a first navigation road section in the historical navigation route is in a clear state based on road condition information of the first navigation road section in the historical navigation route. The method may also include determining the first navigation road section in the historical navigation route as the next navigation road section which the first user terminal enters after the first user terminal passes through the current navigation road section in response to detecting that the first navigation road section in the historical navigation route is in the clear state. The method may further include sending navigation information of the first navigation road section in the historical navigation route to the first user terminal.

In some embodiments, after detecting whether a first navigation road section in the historical navigation route is in a clear state based on road condition information of the first navigation road section in the historical navigation route, the method may further include determining a predicted navigation route that the first user terminal reaches the travel end position from the road section end position in response to detecting that the first navigation road section in the historical navigation route is not in the clear state. The method may include determining a first navigation road section in the predicted navigation route as the next navigation road section which the first user terminal enters after the first user terminal passes through the current navigation road section. The method may further include sending navigation information of the first navigation road section in the predicted navigation route to the first user terminal.

In some embodiments, the determining a predicted navigation route that the first user terminal reaches the travel end position from the road section end position may include determining a plurality of candidate navigation routes that the first user terminal reaches the travel end position from the road section end position; and determining the predicted navigation route from the plurality of candidate navigation routes based on road condition information of a first navigation road section in each of the plurality of candidate navigation routes.

In some embodiments, the determining the predicted navigation route from the plurality of candidate navigation routes based on road condition information of a first navigation road section in each of the plurality of candidate navigation routes may include selecting a first navigation road section that satisfies a preset passing condition from first navigation road sections corresponding to the plurality of candidate navigation routes based on the road condition information of the first navigation road section in the each of the plurality of candidate navigation routes; and determining a candidate navigation route including the first navigation road section that satisfies the preset passing condition as the predicted navigation route.

In some embodiments, the preset passing condition may include a minimum passing time, a shortest passing distance, a minimum number of signal lights, a minimum charge, or the like, or any combination thereof.

In some embodiments, after in response to detecting that the first navigation road section in the historical navigation route is not in the clear state, determining a predicted navigation route that the first user terminal reaches the travel end position from the road section end position, the method may further include determining whether there is a third user terminal within a preset time range after the predicted navigation route is determined. A travel plan of the third user terminal may be from the road section end position to the travel end position. The method may include sharing the navigation information of the first navigation road section in the predicted navigation route to the third user terminal in response to determining that there is a third user terminal.

In some embodiments, before determining whether there is a second user terminal that is travelling within a same time period as the first user terminal, the method may further include obtaining a travel request of the first user terminal. The travel request may include a travel start position and the travel end position. The method may include obtaining, based on the travel start position and the travel end position, a prior navigation route that a fourth user terminal reaches the travel end position from the travel start position. The method may also include determining a first navigation road section in the prior navigation route as the current navigation road section. The method may further include sending navigation information of the first navigation road section in the prior navigation route to the first user terminal.

In some embodiments, before determining whether there is a second user terminal that is travelling within a same time period as the first user terminal, the method may further include obtaining a travel request of the first user terminal. The travel request may include a travel start position and the travel end position. The method may include determining, based on the travel start position and the travel end position, an initial navigation route that the first user terminal reaches the travel end position from the travel start position. The method may also include determining a first navigation road section in the initial navigation route as the current navigation road section. The method may further include sending navigation information of the first navigation road section in the initial navigation route to the first user terminal.

In some embodiments, the determining a first navigation road section in the shared navigation route as a next navigation road section which the first user terminal enters after the first user terminal passes through the current navigation road section may include determining a first target road section in the shared navigation route, wherein a preset count of road sections is located between the first target road section and the current navigation road section; and determining the first target road section as the next navigation road section that the first user terminal enters.

In some embodiments, the determining a first navigation road section in the shared navigation route as a next navigation road section which the first user terminal enters after the first user terminal passes through the current navigation road section may include determining a second target road section in the shared navigation route, wherein a spacing distance between the second target road section and the road section end position is larger than a preset distance threshold; and determining the second target road section as the next navigation road section that the first user terminal enters.

Another aspect of the present disclosure relates to a device for sharing navigation information. The device may include a first determination module, a first acquisition module, and a first sending module. The first determination module may be configured to determine, based on a road section end position of a current navigation road section and a travel end position of a first user terminal, whether there is a second user terminal that is travelling within a same time period as the first user terminal when the first user terminal is travelling on the current navigation road section. A travel plan of the second user terminal may be from the road section end position to the travel end position. The first acquisition module may be configured to obtain a shared navigation route that the second user terminal reaches the travel end position from the road section end position in response to determining that there is the second user terminal that is travelling within the same time period as the first user terminal. The first sending module may be configured to determine a first navigation road section in the shared navigation route as a next navigation road section which the first user terminal enters after the first user terminal passes through the current navigation road section, and send navigation information of the first navigation road section in the shared navigation route to the first user terminal.

In some embodiments, the device for sharing navigation information may further include a second acquisition module, a detection module, and a second sending module. The second acquisition module may be configured to obtain a stored historical navigation route from the road section end position to the travel end position based on the road section end position of the current navigation road section and the travel end position of the first user terminal in response to determining that there is no second user terminal that is travelling within the same time period as the first user terminal. The detection module may be configured to detect whether a first navigation road section in the historical navigation route is in a clear state based on road condition information of the first navigation road section in the historical navigation route. The second sending module may be configured to determine the first navigation road section in the historical navigation route as the next navigation road section which the first user terminal enters after the first user terminal passes through the current navigation road section, and send navigation information of the first navigation road section in the historical navigation route to the first user terminal in response to detecting that the first navigation road section in the historical navigation route is in the clear state.

In some embodiments, the device for sharing navigation information may further include a second determination module and a third sending module. The second determination module may be configured to determine a predicted navigation route that the first user terminal reaches the travel end position from the road section end position in response to detecting that the first navigation road section in the historical navigation route is not in the clear state. The third sending module may be configured to determine a first navigation road section in the predicted navigation route as the next navigation road section which the first user terminal enters after the first user terminal passes through the current navigation road section, and send navigation information of the first navigation road section in the predicted navigation route to the first user terminal.

In some embodiments, the second determination module may be configured to determine a plurality of candidate navigation routes that the first user terminal reaches the travel end position from the road section end position; and determine the predicted navigation route from the plurality of candidate navigation routes based on road condition information of a first navigation road section in each of the plurality of candidate navigation routes.

In some embodiments, the second determination module may be further configured to select a first navigation road section that satisfies a preset passing condition from first navigation road sections corresponding to the plurality of candidate navigation routes based on the road condition information of the first navigation road section in the each of the plurality of candidate navigation routes; and determine a candidate navigation route including the first navigation road section that satisfies the preset passing condition as the predicted navigation route.

In some embodiments, the preset passing condition may include a minimum passing time, a shortest passing distance, a minimum number of signal lights, a minimum charge, or the like, or any combination thereof.

In some embodiments, the device for sharing navigation information may further include a third determination module and a sharing module. The third determination module may be configured to determine whether there is a third user terminal within a preset time range after the predicted navigation route is determined, wherein a travel plan of the third user terminal is from the road section end position to the travel end position. The sharing module may be configured to share the navigation information of the first navigation road section in the predicted navigation route to the third user terminal in response to determining that there is a third user terminal.

In some embodiments, the device for sharing navigation information may further include a third acquisition module, a fourth acquisition module, and a fourth sending module. The third acquisition module may be configured to obtain a travel request of the first user terminal, wherein the travel request includes a travel start position and the travel end position. The fourth acquisition module may be configured to obtain, based on the travel start position and the travel end position, a prior navigation route that a fourth user terminal reaches the travel end position from the travel start position. The fourth sending module may be configured to determine a first navigation road section in the prior navigation route as the current navigation road section, and send navigation information of the first navigation road section in the prior navigation route to the first user terminal.

In some embodiments, the device for sharing navigation information may further include a third acquisition module, a fourth acquisition module, and a fourth sending module. The third acquisition module may be configured to obtain a travel request of the first user terminal, wherein the travel request includes a travel start position and the travel end position. The fourth determination module may be configured to determine, based on the travel start position and the travel end position, an initial navigation route that the first user terminal reaches the travel end position from the travel start position. The fourth sending module may be configured to determine a first navigation road section in the initial navigation route as the current navigation road section, and send navigation information of the first navigation road section in the initial navigation route to the first user terminal.

In some embodiments, the first sending module may be configured to determine a first target road section in the shared navigation route, wherein a preset count of road sections are located between the first target road section and the current navigation road section; and determine the first target road section as the next navigation road section that the first user terminal enters.

In some embodiments, the first sending module may be configured to determine a second target road section in the shared navigation route, wherein a spacing distance between the second target road section and the road section end position is larger than a preset distance threshold; and determine the second target road section as the next navigation road section that the first user terminal enters.

A further aspect of the present disclosure relates to an electronic device including a processor and a storage. The storage may store a machine-readable instruction that is executed on the processor. When the processor executes the machine-readable instruction, operations of the method for sharing navigation information may be implemented.

A still further aspect of the present disclosure relates to a computer readable storage medium storing a computer program thereon. When the computer program is executed by a processor, operations of the method for sharing navigation information may be implemented.

The method and device for sharing navigation information provided in some embodiments of the present disclosure may determine, based on a road section end position of a current navigation road section and a travel end position of a first user terminal, whether there is a second user terminal that is travelling within a same time period as the first user terminal when the first user terminal is travelling on the current navigation road section. A travel plan of the second user terminal may be from the road section end position to the travel end position. The method and device may obtain a shared navigation route that the second user terminal reaches the travel end position from the road section end position in response to determining that there is the second user terminal that is travelling within the same time period as the first user terminal. The method and device may determine a first navigation road section in the shared navigation route as a next navigation road section which the first user terminal enters after the first user terminal passes through the current navigation road section, and send navigation information of the first navigation road section in the shared navigation route to the first user terminal. In this case, when a user is travelling, a navigation route may be obtained by determining a plurality of road sections in the entire route on which the user travels. In addition, each existing real-time shared navigation route for each upcoming road section may be obtained, thereby achieving the sharing of the navigation route. The computation load for navigation data may be effectively reduced. The occupation and waste of computing resources may be reduced. Further, the convenience and smoothness of travel by the user terminal may be ensured, which is beneficial in improving the experience of the user terminal.

### BRIEF DESCRIPTION OF THE DRAWINGS

In order to more clearly illustrate the technical solution of the present disclosure, the following description is presented to briefly describe drawings used in some embodiments. It should be understood that the following drawings are merely shown in some embodiments of the present disclosure without departing from the scope of the present disclosure. For skilled in the art, related drawings may be obtained based on the drawings without the premise of creative labor.

FIG. 1 is a schematic diagram illustrating exemplary hardware and/or software components of an exemplary electronic device that can implement the idea of the present disclosure according to some embodiments of the present disclosure;

FIG. 2 is a flowchart illustrating an exemplary process for a method for sharing navigation information according to some embodiments of the present disclosure;

FIG. 3 is another flowchart illustrating an exemplary process for a method for sharing navigation information according to some embodiments of the present disclosure;

FIG. 4 is a schematic diagram illustrating a structure of a device for sharing navigation information according to some embodiments of the present disclosure;

FIG. 5 is a schematic diagram illustrating a structure of a device for sharing navigation information according to some embodiments of the present disclosure; and

FIG. 6 is a schematic diagram illustrating a structure of a device for sharing navigation information according to some embodiments of the present disclosure.

### DETAILED DESCRIPTION

In order to make the purposes, the technical solution, and advantages of the present disclosure more clearly, the technical solutions in the present disclosure may be described clearly and completely with reference to the accompanying drawings in some embodiments of the present disclosure. It should be understood that the drawings are merely for the purposes of illustration and description, and are not intended to limit the protection scope of the present disclosure. In addition, it should be understood that the schematic drawings are not to scale. The flowchart used in the present disclosure illustrates operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

In addition, the described embodiment is merely implemented in the embodiment, not all embodiments. Components in some embodiments of the present disclosure described and illustrated in the drawings herein may be arranged and designed in a variety of different configurations. Thus, the detailed description in some embodiments of the present disclosure provided in the drawings is not intended to limit the scope of the present disclosure, but only selected embodiments of the present disclosure. Based on the embodiments of the present disclosure, other embodiments that are obtained by those skilled in the art without creative labor are within the scope of the present disclosure.

In order to enable those skilled in the art to use the content of the present disclosure, the following embodiments are given with reference to a specific application scenario of “obtaining a travel route for a user through a shared navigation route during a driving process.” For those skilled in the art, the general principles defined herein may be applied to other embodiments and application scenarios without departing from the spirit and scope of the present disclosure. Although the present disclosure mainly describes how to obtain shared navigation routes during the driving process, it should be understood that this is merely some embodiments. The present disclosure may be applied to any different types of travel tools or travel manners to share the navigation route. The system or method in the present disclosure may be applied to applications including servers, clients, custom systems, internal analysis systems, artificial intelligent interaction terminals, or the like, or any combination thereof.

It should be noted that the term “comprising” will be used in some embodiments of the present disclosure for indicating the presence of the features declared thereafter, but not exclude additional features.

It should be noted that when a user goes to a strange place, or when a route is not familiar, the user may use navigation software, etc. to generate a navigation route and travel based on the navigation route before the travelling (e.g., driving). However, with a sharp increase of the number of users, a plan of a navigation route for each user (especially during a navigation process, there is also a real-time adjustment of the navigation route with changes of road conditions) may be no doubt to greatly increase the computation load of a background processor and the occupation of computing resources, resulting in a lot of affordable and resource waste.

For this, an aspect of the present disclosure provides a method for sharing navigation information. When a user is travelling, a navigation route may be obtained by determining a plurality of road sections in the entire route on which the user travels. In addition, each existing real-time shared navigation route for each upcoming road section may be obtained, thereby achieving the sharing of the navigation route. The computation load for navigation data may be effectively reduced. The occupation and waste of computing resources may be reduced. Further, the convenience and smoothness of travel by the user terminal may be ensured, which is beneficial in improving the experience of the user terminal.

Embodiments of the present disclosure may be implemented by a cloud platform, a server, or a server group (hereinafter collectively referred to as a service system) interacting with a user, and may also be implemented directly by a user terminal. The user terminal, in some embodiments of the present disclosure, may be understood as a terminal device, or a user terminal that the user registered on a platform. The terminal device may be understood as a mobile terminal, a personal computer (PC), an in-vehicle terminal, and any devices that can be used to install a platform application.

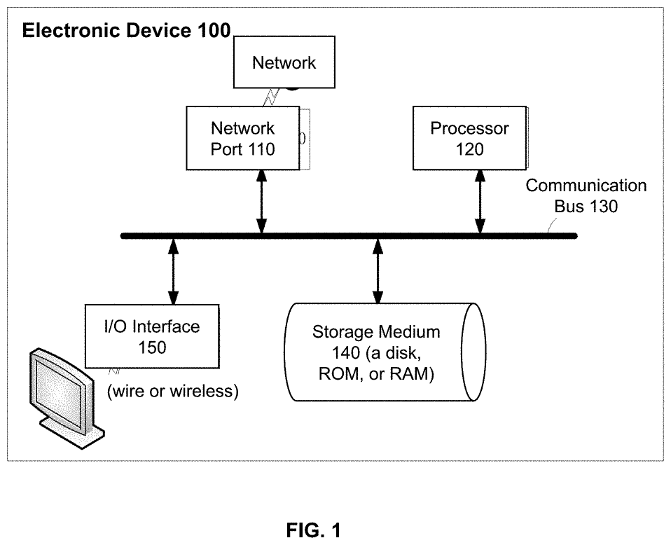

In some embodiments, the service system may be a single server or a server group. The server group may be a centralized or distributed server group. For example, the service system may be a distributed system. In some embodiments, the service system may be local or remote to the terminal device. For example, the service system may access information and/or data stored in the user terminal, a database, or any combination thereof, via a network. In some embodiments, the service system may be implemented on the cloud platform. For example, the cloud platform may include a private cloud, a public cloud, a mixed cloud, a community cloud, a distributed cloud, an inter-cloud, a multi-cloud, or any combination thereof. In some embodiments, the service system may be implemented on an electronic device 100 including one or more components shown in FIG. 1 of the present disclosure.

In some embodiments, the service system may include a processor. The process may process information and/or data related to a service request to perform one or more functions described in the present disclosure. In some embodiments, the processor may include one or more processing cores (e.g., a single-core processor (SCP) or a multi-core processor (MCP)). Merely by way of example, the processor may include a central processing unit (CPU), an application specific integrated circuit (ASIC), an application specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction set computer (RISC), a microprocessor, or the like, or any combination thereof.

FIG. 1 is a schematic diagram illustrating exemplary hardware and/or software components of an exemplary electronic device 100 that can implement the idea of the present disclosure according to some embodiments of the present disclosure. For example, processor 120 may be disposed in the electronic device 100 and configured to perform one or more functions in the present disclosure.

The electronic device 100 may include a general-purpose computer or a special-purpose computer. Both computers may be configured to implement the method for sharing navigation information of the present disclosure. Although only one such computer is shown for convenience, the computer functions related to the method for sharing navigation information as described in the present disclosure may be implemented in a distributed manner on a number of similar platforms to distribute the processing load.

For example, the electronic device 100 may include a network port 110 configured to connect to a network, one or more processors 120 configured to perform instructions, a communication bus 130, and different forms of storage mediums 140, such as a disk, a read only memory (ROM), a random access memory (RAM), or the like, or any combination thereof. For example, a computer platform may also include program instructions stored in ROM, RAM, or other types of non-temporary storage media, or any combination thereof. The method for sharing navigation information in the present disclosure may be implemented based on these program instructions. The electronic device 100 may also include an input/output (I/O) interface 150 between the computer and other input/output devices (e.g., a keyboard, a display screen).

Merely for illustration, only one processor is described in the electronic device 100. However, it should be noted that the electronic device 100 in the present disclosure may include multiple processors, thus operations and/or method steps performed by one processor as described in the present disclosure may also be jointly or separately performed by the multiple processors. For example, if in the present disclosure the processor of the electronic device 100 executes both step A and step B, it should be understood that step A and step B may also be performed by two different CPUs and/or processors jointly or separately (e.g., the first processor executes step A and the second processor executes step B, or the first and second processors jointly execute steps A and B).

The following is a further description of the idea in some embodiments of the present disclosure from an angle of operating the method.

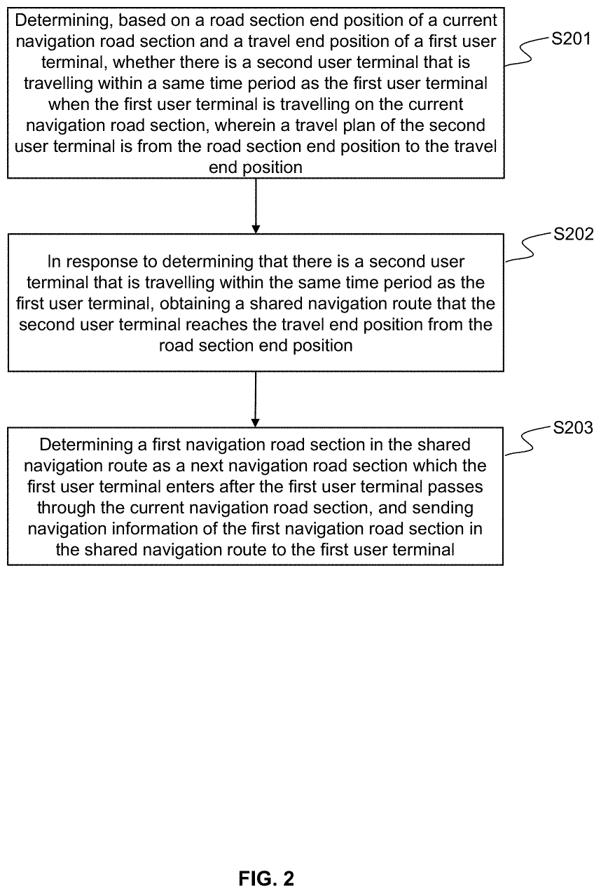

Referring to FIG. 2, FIG. 2 is a flowchart illustrating an exemplary process of a method for sharing navigation information according to some embodiments of the present disclosure. The method is applied to a server or a user terminal. The server may be a backend server, a cloud server, etc. disposed separately, or a background server or a cloud server connected to the user terminal. Alternatively, the server may be a server embedded inside of the user terminal. The user terminal may be a mobile terminal of a driver, or an in-vehicle terminal. As shown in FIG. 2, the method may include the following operations.

In S201, the processor may determine, based on a road section end position of a current navigation road section and a travel end position of a first user terminal, whether there is a second user terminal that is travelling within a same time period as the first user terminal when the first user terminal is travelling on the current navigation road section. A travel plan of the second user terminal may be from the road section end position to the travel end position.

In this operation, when a user drives a vehicle, or when the user travels by the vehicle, a position of the user may be detected by detecting a position of the first user terminal corresponding to the user. Therefore, travel information (e.g., a travel state, a travel position, etc.) of the user may be obtained. When it is detected that the first user terminal is travelling in the current navigation road section, the road section end position of the current navigation road section where the first user terminal is travelling may be determined. The travel end position of the first user terminal may also be obtained. Accordingly, the processor may determine, based on the road section end position of the current navigation road section and the travel end position, whether there is the second user terminal that is travelling on a same route within the same time period as the first user terminal.

The second user terminal refers to a user terminal that is travelling within the same time period as the first user terminal and whose travel plan is from the road section end position to the travel end position. That is, a travel route of the second user terminal may be the same as a route that the first user terminal passes through the current navigation road section.

In the operation of determining whether there is a second user terminal that is travelling within the same time period as the first user terminal, the first user terminal and the second user terminal may be connected to a background server. Alternatively, the first user terminal and the second user terminal may be connected to a service platform. Travel information of the first user terminal and the second user terminal may be uploaded to the background server or the service platform, respectively. In some embodiments, various information may be obtained from the background server or the service platform.

In some embodiments, the processor may determine that the first user terminal is travelling on the current navigation road section. A positioning position of the first user terminal may be determined by a function (e.g., positioning of a global positioning system (GPS)) of the first user terminal. And further, the processor may determine that the first user terminal is travelling on the current navigation road section by detecting the positioning position of the first user terminal.

In the embodiment, an initial navigation route may be planned for the first user terminal based on a travel request of the first user terminal or a travel plan of the first user terminal. Then, a plurality of road sections that can be passed by the first user terminal may be determined by dividing a possible route or a possible region that the first user terminal may pass through based on the initial navigation route.

In this case, navigation may be performed according to the plurality of road sections, which may undoubtedly reduce the computation load of data to some extent. In addition, road conditions of the navigation road section may be obtained in real time to perform a real-time navigation, thereby improving the accuracy and accessibility of the navigation route, and decreasing a navigation delay.

In the embodiment, the travel end position of the first user terminal refers to a final position of a final destination in the travel of the first user. The above manner may be for a situation that the first user terminal has not been travelled according to the initial navigation route when a deviation from the pre-planned initial navigation route is large in the actual travelling of the first user terminal. Alternatively, the travel end position of the first user terminal also refers to a final position of a predicted road section or a final position of a predicted region where the first user terminal will enter that is predicted. The above manner may be for a situation that, since road conditions of the plurality of road sections are different, the navigation route of each of the plurality of road sections may be adjusted when the deviation from the pre-planned initial navigation route is not large in the actual travelling of the first user terminal.

In S202, the processor may obtain a shared navigation route that the second user terminal reaches the travel end position from the road section end position in response to determining that there is the second user terminal that is travelling within the same time period as the first user terminal.

In the operation, if determining that there is a second user terminal that is travelling within the same time period as the first user terminal, it may be regarded that the navigation route from the road section end position to the travel end position has been planned. The shared navigation route that the second user terminal reaches the travel end position from the road section end position may be directly obtained. The first user terminal may use the shared navigation route in a subsequent travel.

The second user terminal that is travelling within the same time period as the first user terminal refers to a second user terminal that a difference between a travel time selected by the second user terminal and a travel time selected by the first user terminal is within a preset time range. For example, the first preset time range may be range from 0 to 5 minutes.

In other words, in this embodiment, it may be understood that a degree of congestion on a same road section in a same time period will not change. That is, if there is a navigation route from the road section end position to the travel end position that is planned for the second user terminal, a degree of congestion of the navigation route may be acceptable for the second user terminal. Therefore, the navigation route may be provided to the first user terminal, and no need to make a navigation plan for the first user separately.

In S203, the processor may determine a first navigation road section in the shared navigation route as a next navigation road section which the first user terminal enters after the first user terminal passes through the current navigation road section, and send navigation information of the first navigation road section in the shared navigation route to the first user terminal.

In the operation, after obtaining the shared navigation route that the second user terminal reaches the travel end position from the road section end position, it may be understood that the first user terminal may travel in the next road section according to the shared navigation route. That is, the first navigation road section in the shared navigation route may be determined as the next navigation road section which the first user terminal will enter after the first user terminal passes through the current navigation road section. Then, the navigation information of the first navigation road section in the shared navigation route may be acquired and sent to the first user terminal. That is, the navigation information of the next navigation road section which the first user terminal will enter may be sent to the first user terminal.

The next navigation road section which the first user terminal enters after the first user terminal passes through the current navigation road section refers to a road section that the first user terminal immediately enters after passing through the current navigation road section. That is, the current navigation road section and the next navigation road section may be two consecutive road sections that are end to end. In some embodiments, the next navigation road section also refers to a road section that the first user terminal does not immediately enter after passing through the current navigation road section. That is, the current navigation road section and the next navigation road section may be two separate and inconsecutive road sections. There may be a certain interval between the current navigation road section and the next navigation road section.

The method for sharing navigation information provided in this embodiment may include determining, based on the road section end position of the current navigation road section and the travel end position of the first user terminal, whether there is a second user terminal that is travelling within the same time period as the first user terminal when the first user terminal is travelling on the current navigation road section, wherein the travel plan of the second user terminal may be from the road section end position to the travel end position. The method may include obtaining the shared navigation route that the second user terminal reaches the travel end position from the road section end position in response to determining that there is the second user terminal that is travelling within the same time period as the first user terminal. The method may further include determining the first navigation road section in the shared navigation route as the next navigation road section which the first user terminal enters after the first user terminal passes through the current navigation road section and sending the navigation information of the first navigation road section in the shared navigation route to the first user terminal.

In this case, in the process of user travel, the navigation route may be obtained by determining different road sections in the entire route of the user travel. The navigate information of the next navigation section of the first user terminal may be progressively determined according to each road section. Therefore, the generated navigate route and the navigate information sent to the first user terminal may be more fitted with the real-time road conditions. In addition, when the navigated road section is obtained, the navigation route that has been planned for other terminals in the same time period may be obtained, so as to realize the sharing of the navigation route. Therefore, performing navigation planning repeatedly for different users on the same route in the same time period may be avoided. The computation load for navigation data may be effectively reduced. The occupation and waste of computing resources may be reduced. Further, the convenience and smoothness of travel by the user terminal may be ensured, which is beneficial in improving the experience of the user terminal.

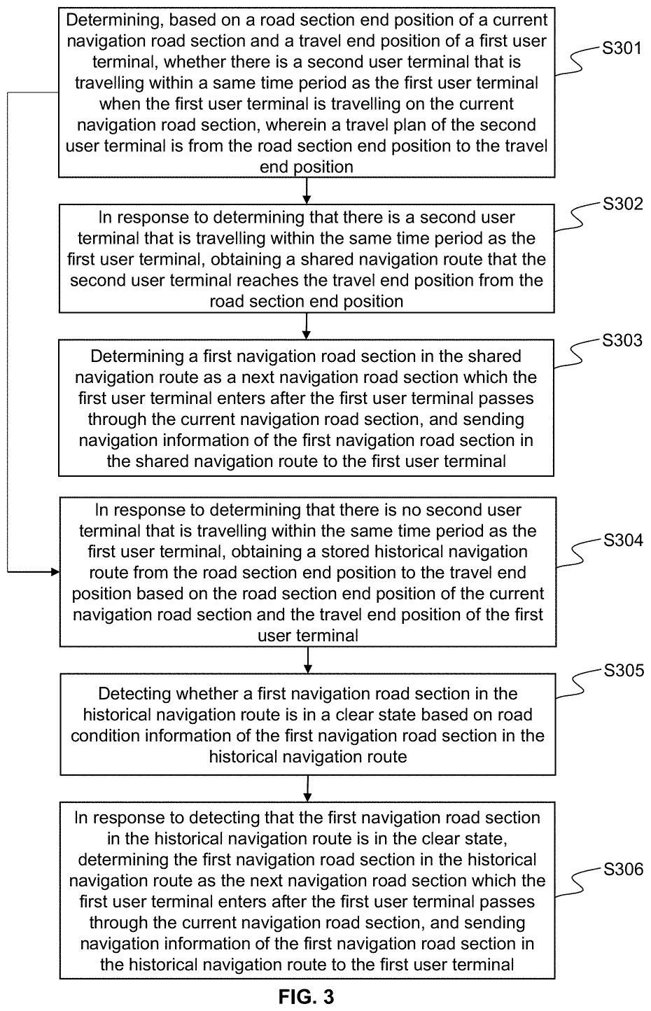

Referring to FIG. 3, FIG. 3 is a flowchart illustrating an exemplary process for a method for sharing navigation information according to some embodiments of the present disclosure. The method is applied to a server or a user terminal. The server may be a backend server, a cloud server, etc. disposed separately, or a background server or a cloud server connected to the user terminal. Alternatively, the server may be a server embedded inside of the user terminal. The user terminal may be a mobile terminal of a driver, or an in-vehicle terminal. As shown in FIG. 3, the method may include the following operations.

In S301, the processor may determine, based on a road section end position of a current navigation road section and a travel end position of a first user terminal, whether there is a second user terminal that is travelling within a same time period as the first user terminal when the first user terminal is travelling on the current navigation road section. A travel plan of the second user terminal may be from the road section end position to the travel end position.

In S302, the processor may obtain a shared navigation route that the second user terminal reaches the travel end position from the road section end position in response to determining that there is a second user terminal that is travelling within the same time period as the first user terminal.

In S303, the processor may determine a first navigation road section in the shared navigation route as a next navigation road section which the first user terminal enters after the first user terminal passes through the current navigation road section, and send navigation information of the first navigation road section in the shared navigation route to the first user terminal.

In S304, the processor may obtain a stored historical navigation route from the road section end position to the travel end position based on the road section end position of the current navigation road section and the travel end position of the first user terminal in response to determining that there is no second user terminal that is travelling within the same time period as the first user terminal.

In this operation, if it is determined that there is no second user terminal that is travelling within the same time period as the first user terminal based on the road section end position of the current navigation road section and the travel end position of the first user terminal, it may be understood that there is no user who travels using the road section end position and the travel end position as starting points. That is, a navigation of the road section whose degree of congestion can be accepted in the current time period may not have been generated. In this case, the historical navigation route from the road section end position to the travel end position may be determined from stored information based on the road section end position of the current navigation road section and a travel route corresponding to the travel end position of the first user terminal.

The historical navigation route may be a navigation route that is obtained and stored in a time prior to the travel time of the first user terminal, but within a time period relatively closed to the travel time of the first user terminal.

In S305, the processor may detect whether a first navigation road section in the historical navigation route is in a clear state based on road condition information of the first navigation road section in the historical navigation route.

In this operation, after the historical navigation route is obtained, the first navigation road section in the historical navigation route may be determined. Then, the road condition information of the first navigation road section may be obtained. The processor may detect whether the first navigation road section in the historical navigation route is in the clear state based on the road condition information. That is, the processor may determine whether the first user terminal can pass the first navigation road section in the historical navigation route.

The obtained road condition of the first navigation road section may be obtained from a cloud server. The road information of the first navigation road section in the historical navigation route may be acquired by an acquisition device and stored in the cloud server. The road information may include road condition whether there is a traffic jam on the road section, whether a traffic accident is happened to cause a slow pass, whether the road section is closed to traffic due to construction, etc., traffic signals, a traffic flow (traffic volume) on the road section, a flow of people on the road section, etc.

The clean state refers that the first user terminal can pass in a shorter time, a passing distance is shorter, a waiting time is less, a charge is less, etc.

In other words, if there is no second user terminal that is travelling within the same time period as the first user terminal, it may be understood that there is not a navigation route that can reach the travel end position of the first user terminal and a degree of congestion can be accepted. Therefore, it may need to search a historical navigation route that can reach the travel end position of the first user terminal through the operation S304 at first. Then, although the historical navigation route can reach the travel end position of the first user, a current congestion of the historical navigation route may be unknown. It may be necessary to determine whether the congestion on the historic navigation route through the operation S305.

In S306, the processor may determine the first navigation road section in the historical navigation route as the next navigation road section which the first user terminal enters after the first user terminal passes through the current navigation road section, and send navigation information of the first navigation road section in the historical navigation route to the first user terminal in response to detecting that the first navigation road section in the historical navigation route is in the clear state.

In the operation, if it is determined that the first navigation road section in the historical navigation route is in the clean state, it may be understood that the first user terminal may travel in the next section according to the historical navigation route. That is, the first navigation road section in the historical navigation route may be determined as the next navigation road section which the first user terminal will enter after the first user terminal passes through the current navigation road section. Then, the navigation information of the first navigation road section in the historical navigation route may be acquired and sent to the first user terminal. That is, the navigation information of the next navigation road section which the first user terminal will enter may be sent to the first user terminal.

In some embodiments, after operation S305, the method may also include the following operations.

The processor may determine a predicted navigation route that the first user terminal reaches the travel end position from the road section end position in response to detecting that the first navigation road section in the historical navigation route is not in the clear state. The processor may determine a first navigation road section in the predicted navigation route as the next navigation road section which the first user terminal enters after the first user terminal passes through the current navigation road section, and send navigation information of the first navigation road section in the predicted navigation route to the first user terminal.

In the operation, if it is determined that the first navigation road section in the historical navigation route is not in the clean state, it may be understood that the first user terminal can not pass smoothly in the first navigation road section in the historical navigation route. A passable route may be replanned for the first user terminal. In some embodiments, the predicted navigation route from the road section end position to the travel end position may be planned based on the road section end position and the travel end position. That is, the first user terminal may reach the travel end position from the road section end position by travelling based on the predicted navigation route. Further, the processor may determine the first navigation road section in the predicted navigation route as the next navigation road section which the first user terminal enters after the first user terminal passes through the current navigation road section. Then, the navigation information of the first navigation road section in the predicted navigation route may be acquired and sent to the first user terminal. That is, the navigation information of the next navigation road section which the first user terminal will enter may be sent to the first user terminal. The next navigation road section may be used by the first user terminal.

Since the travel end position of the first user terminal may be a final position of the final destination of the first user, or may be a final position of a predicted road section or a final position of a predicted region where the first user terminal will enter that is predicted, the predicted navigation route may be a navigation route between the road section end position of the navigation road section and the final position of the final destination of the first user. Alternatively, the predicted navigation route may be a navigation route from the road section end position of the navigation road section to the final position of the predicted road section or the final position of the predicted region.

Further, in the above embodiment, the determining a predicted navigation route that the first user terminal reaches the travel end position from the road section end position may include determining a plurality of candidate navigation routes that the first user terminal reaches the travel end position from the road section end position, and determining the predicted navigation route from the plurality of candidate navigation routes based on road condition information of a first navigation road section in each of the plurality of candidate navigation routes.

In this operation, after the road section end position and the travel end position of the travel of the first user terminal are obtained, the plurality of candidate navigation routes may be generated based on the road section end position and the travel end position. The generated plurality of candidate navigation routes may be determined for the first user terminal from the road section end position to the travel end position. Then, for the first navigation road section in each of the plurality of candidate navigation routes, the road condition information of the first navigation road section in each of the plurality of candidate navigation routes may be obtained. A candidate navigation route with an optimal road condition may be determined from the plurality of candidate navigation routes based on the road condition information of the first navigation road section in each of the plurality of candidate navigation routes. The determined candidate navigation route may be determined as the predicted navigation route that can be used by the first user terminal.

The obtaining the road condition information of the first navigation road section in each of the plurality of candidate navigation routes may be obtained from a cloud server. The road information of the first navigation road section in each of the plurality of candidate navigation routes may be acquired by an acquisition device and stored in the cloud server. The road information may include road condition whether there is a traffic jam on the road section, whether a traffic accident is happened to cause a slow pass, whether the road section is closed to traffic due to construction, etc., traffic signals, a traffic flow (traffic volume) on the road section, a flow of people on the road section, etc.

In some embodiments, the determining the predicted navigation route from the plurality of candidate navigation routes based on the road condition information of the first navigation road section in each of the plurality of candidate navigation routes may include selecting a first navigation road section that satisfies a preset passing condition from first navigation road sections corresponding to the plurality of candidate navigation routes based on the road condition information of the first navigation road section in the each of the plurality of candidate navigation routes. The road condition information may include road condition information, such as which first navigation road section is smooth, a traffic flow is small, the traffic light allows traffic, etc. Then, a candidate navigation route including the first navigation road section that satisfies the preset passing condition may be determined as the predicted navigation route.

In some embodiments, the preset passing condition may include a minimum passing time, a shortest passing distance, a minimum number of signal lights, a minimum charge, or the like, or any combination thereof.

In this case, the optimal navigation route for the user travel may be determined based on the real-time road information of the road, to reduce traffic jams and other situations that may result from the user travel, thereby improving the efficiency of user travel, and being beneficial in improving user experience.

In some embodiments, after in response to detecting that the first navigation road section in the historical navigation route is not in the clear state, determining a predicted navigation route that the first user terminal reaches the travel end position from the road section end position, the method may further include determining whether there is a third user terminal which travels within a preset time range after the predicted navigation route is determined. As used herein, a travel plan of the third user terminal may be from the road section end position to the travel end position. The method may include sharing the navigation information of the first navigation road section in the predicted navigation route to the third user terminal in response to determining that there is a third user terminal.

In the operation, after determining the predicted navigation route, users who have a subsequent travel plan may be detected, so that whether there is the third user terminal which travels within the preset time range after the predicted navigation route is determined may be determined. The travel plan of the third user terminal may also be from the road section end position to the travel end position. If there is a third user terminal, and the travel plan of the third user terminal is also from the road section end position to the travel end position, it may be understood that the third user terminal may travel according to the predicted navigation route. Therefore, the navigation information of the first navigation road section in the predicted navigation route may be shared to the third user terminal that can be used by the third user terminal.

It should be noted that in some alternative embodiments, only the predicted navigation routes that are specifically obtained for the first user terminal may be shared to the third user terminal. The shared navigation route that the first user terminal obtains from the second user terminal may not be shared to the third user terminal by the first user terminal.

In some embodiments, before determining whether there is a second user terminal that is travelling within a same time period as the first user terminal, the method may further include obtaining a travel request of the first user terminal. The travel request may include a travel start position and the travel end position. The method may include obtaining, based on the travel start position and the travel end position, a prior navigation route that a fourth user terminal reaches the travel end position from the travel start position. The method may further include determining a first navigation road section in the prior navigation route as the current navigation road section, and sending navigation information of the first navigation road section in the prior navigation route to the first user terminal.

In the operation, when the user corresponding to the first user is required to travel, the travel request of the first user terminal may be obtained by receiving information transmitted by the first user terminal, extracting information from the first user terminal, etc. After the first user terminal is acquired the travel request including the travel start position and the travel end position, the prior navigation route corresponding to the travel start position and the travel end position that the fourth user terminal has used may be determined from stored historical travel data or information based on the travel start position and the travel end position. The first navigation road section in the prior navigation route may be determined as the navigation road section that the first user terminal will take at a beginning of the travelling. Therefore, the navigation information of the first navigation road section in the prior navigation route may be extracted. The navigation information of the first navigation road section in the prior navigation route may be sent to the first user terminal. That is, the information of the current navigation section may be sent to the first user terminal.

The travel request may include the travel start position and the travel end position. The travel end position in the travel request herein refers to a final position of the final destination of the first user terminal. The fourth user terminal may be a terminal different from the first user terminal. That is, the user may obtain the prior navigation route including the same travel start position and the same travel end position used by other users. In some embodiments, the fourth user terminal may also be a terminal device same as the first user terminal. That is, the user may obtain the used prior navigation route from the travel start position and the travel end position.

In some other embodiments, before determining whether there is a second user terminal that is travelling within a same time period as the first user terminal, the method may further include obtaining a travel request of the first user terminal. As used herein, the travel request may include a travel start position and the travel end position. The method may include determining, based on the travel start position and the travel end position, an initial navigation route that the first user terminal reaches the travel end position from the travel start position. The method may further include determining a first navigation road section in the initial navigation route as the current navigation road section, and sending navigation information of the first navigation road section in the initial navigation route to the first user terminal.

In other words, after obtaining the travel request of the first user terminal, the initial navigation route may be planned directly for the first user terminal based on the travel request.

In this embodiment, the initial navigation route may be that if the first user terminal travels, when the first user terminal is started to travel, the first user terminal may enter the first navigation road section of the initial navigation route and begin to travel.

In some embodiments, the determining a first navigation road section in the shared navigation route as a next navigation road section which the first user terminal enters after the first user terminal passes through the current navigation road section may include determining a first target road section in the shared navigation route, wherein a preset count of road sections may be located between the first target road section and the current navigation road section. The first target road section may be determined as the next navigation road section that the first user terminal enters.

In the operation, after determining the shared navigation route that can be used by the first user terminal, real-time road condition information of each road section in the shared navigation route may be used to learn a passing situation of each road section in the shared navigation route. Therefore, the first target road section that the user can smoothly pass may be determined in the shared navigation route. The first target road section may be determined as the next navigation road section, i.e., the next navigation road section that the user can pass.

The first target road section may be the preset count of road sections which are smooth passages located between the first target road section and the current navigation road section in the shared navigation route.

In this case, by the determination of a traffic state of a road section that the preset count of road sections are located between the road section and the current navigation road section, and designating the road section as the first target road section that the user can pass smoothly when the road section is under a clean state, a certain buffer time may be provided to the user to avoid causing that the user may not enter the target section (i.e., the next navigation section) that can smoothly pass in time since a distance is too short, or a time is insufficient.

In some embodiments, the determining a first navigation road section in the shared navigation route as a next navigation road section which the first user terminal enters after the first user terminal passes through the current navigation road section may include determining a second target road section in the shared navigation route, wherein a spacing distance between the second target road section and the road section end position may be larger than a preset distance threshold. The second target road section may be determined as the next navigation road section that the first user terminal enters.

In the operation, after determining the shared navigation route that can be used by the first user terminal, the real-time road condition information of each road section in the shared navigation route may be used to learn a passing situation of each road section in the shared navigation route. Therefore, the second target road section that the user can smoothly pass and the spacing distance between the second target road section and the road section end position is larger than the preset distance threshold may be determined in the shared navigation route. The second target road section may be determined as the next navigation road section, i.e., the next navigation road section that the user can pass.

In this case, by the determination of a traffic state of a road section that the spacing distance between the road section and the current navigation sections is greater than the preset distance threshold, and designating the road section as the second target road section that the user can pass smoothly when the road section is under a clean state, a certain buffer time may be provided to the user to avoid causing that the user may not enter the target section (i.e., the next navigation section) that can smoothly pass in time since a distance is too short, or a time is insufficient.

The method for sharing navigation information provided in this embodiment may include determining, based on the road section end position of the current navigation road section and the travel end position of the first user terminal, whether there is a second user terminal that is travelling within the same time period as the first user terminal when the first user terminal is travelling on the current navigation road section, wherein the travel plan of the second user terminal may be from the road section end position to the travel end position. The method may include obtaining the shared navigation route that the second user terminal reaches the travel end position from the road section end position in response to determining that there is a second user terminal that is travelling within the same time period as the first user terminal. The method may further include determining the first navigation road section in the shared navigation route as the next navigation road section which the first user terminal enters after the first user terminal passes through the current navigation road section and sending the navigation information of the first navigation road section in the shared navigation route to the first user terminal. The method may include obtaining the stored historical navigation route from the road section end position to the travel end position based on the road section end position of the current navigation road section and the travel end position of the first user terminal in response to determining that there is no second user terminal that is travelling within the same time period as the first user terminal. The method may include detecting whether the first navigation road section in the historical navigation route is in the clear state based on the road condition information of the first navigation road section in the historical navigation route. The method may further include determining the first navigation road section in the historical navigation route as the next navigation road section which the first user terminal enters after the first user terminal passes through the current navigation road section, and sending navigation information of the first navigation road section in the historical navigation route to the first user terminal in response to detecting that the first navigation road section in the historical navigation route is in the clear state.

In this case, in the process of user travel, the navigation route may be obtained by determining different road sections in the entire route of the user travel. Each existing real-time shared navigation route that will enter the road section, or the existing historical navigation route may be obtained, so as to realize the sharing of the navigation route. Therefore, the computation load for navigation data may be effectively reduced. The occupation and waste of computing resources may be reduced. Further, the convenience and smoothness of travel by the user terminal may be ensured, which is beneficial in improving the experience of the user terminal.

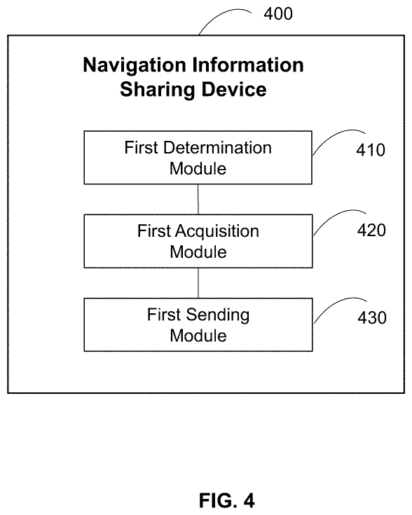

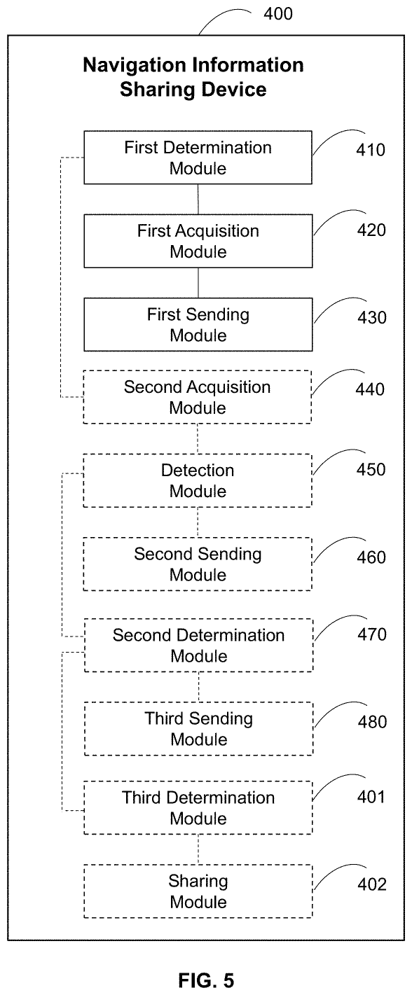

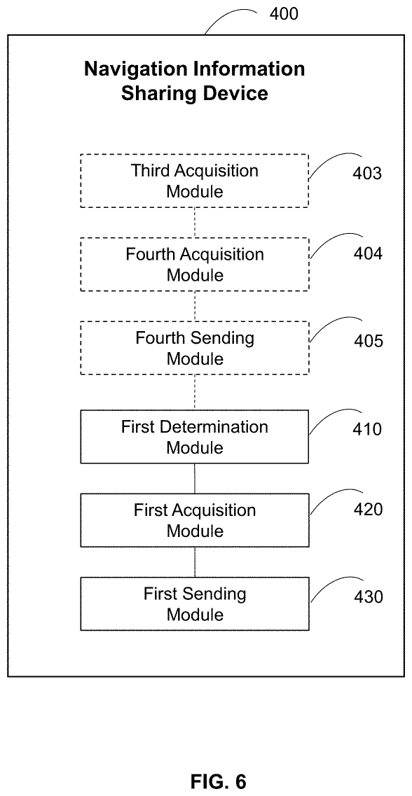

Referring to FIGS. 4-6, FIG. 4 is a schematic diagram illustrating a structure of a device for sharing navigation information according to some embodiments of the present disclosure. FIG. 5 is a schematic diagram illustrating a structure of a device for sharing navigation information according to some embodiments of the present disclosure. FIG. 6 is a schematic diagram illustrating a structure of a device for sharing navigation information according to some embodiments of the present disclosure. A device 400 for sharing navigation information may be configured to implement operations performed by the method for sharing navigation information. The device 400 may be understood as the above server or a processor of the server. Alternatively, the device 400 may also be understood as a component that implements functions of the present disclosure under a control of the server independently of the server or the processor. As shown in FIG. 4, the device 400 may include a first determination module 410, a first acquisition module 420, and a first sending module 430.

The first determination module may be configured to determine, based on a road section end position of a current navigation road section and a travel end position of a first user terminal, whether there is a second user terminal that is travelling within a same time period as the first user terminal when the first user terminal is travelling on the current navigation road section. A travel plan of the second user terminal is from the road section end position to the travel end position.

The first acquisition module may be configured to obtain a shared navigation route that the second user terminal reaches the travel end position from the road section end position in response to determining that there is a second user terminal that is travelling within the same time period as the first user terminal.

The first sending module 430 may be configured to determine a first navigation road section in the shared navigation route as a next navigation road section which the first user terminal enters after the first user terminal passes through the current navigation road section, and send navigation information of the first navigation road section in the shared navigation route to the first user terminal.

In some embodiments, as shown in FIG. 5, the device 400 for sharing navigation information may also include a second acquisition module 440, a detection module 450, and a second sending module 460.

The second acquisition module 440 may be configured to obtain a stored historical navigation route from the road section end position to the travel end position based on the road section end position of the current navigation road section and the travel end position of the first user terminal in response to determining that there is no second user terminal that is travelling within the same time period as the first user terminal.

The detection module 450 may be configured to detect whether a first navigation road section in the historical navigation route is in a clear state based on road condition information of the first navigation road section in the historical navigation route.

The second sending module 460 may be configured to determine the first navigation road section in the historical navigation route as the next navigation road section which the first user terminal enters after the first user terminal passes through the current navigation road section, and send navigation information of the first navigation road section in the historical navigation route to the first user terminal in response to detecting that the first navigation road section in the historical navigation route is in the clear state.

In some implementations, as shown in FIG. 5, the device 400 for sharing navigation information may also include a second determination module 470 and a third sending module 480.

The second determination module 470 may be configured to determine a predicted navigation route that the first user terminal reaches the travel end position from the road section end position in response to detecting that the first navigation road section in the historical navigation route is not in the clear state.

The third sending module 480 may be configured to determine a first navigation road section in the predicted navigation route as the next navigation road section which the first user terminal enters after the first user terminal passes through the current navigation road section, and send navigation information of the first navigation road section in the predicted navigation route to the first user terminal.

In some embodiments, the second determination module 470 may be specifically configured to determine a plurality of candidate navigation routes that the first user terminal reaches the travel end position from the road section end position, and determine the predicted navigation route from the plurality of candidate navigation routes based on road condition information of a first navigation road section in each of the plurality of candidate navigation routes.

In the above embodiment, the second determination module 470 may also be specifically configured to select a first navigation road section that satisfies a preset passing condition from first navigation road sections corresponding to the plurality of candidate navigation routes based on the road condition information of the first navigation road section in the each of the plurality of candidate navigation routes; and determine a candidate navigation route including the first navigation road section that satisfies the preset passing condition as the predicted navigation route.

In the above embodiment, the preset passing condition may include a minimum passing time, a shortest passing distance, a minimum number of signal lights, a minimum charge, or the like, or any combination thereof.

In some implementations, as shown in FIG. 5, the device 400 for sharing navigation information may further include a third determination module 401 and a sharing module 402.

The third determination module 401 may be configured to determine whether there is a third user terminal within a preset time range after the predicted navigation route is determined, wherein a travel plan of the third user terminal is from the road section end position to the travel end position.

The shared module 402 may be configured to share the navigation information of the first navigation road section in the predicted navigation route to the third user terminal in response to determining that there is a third user terminal.

In some implementations, as shown in FIG. 6, the device 400 for sharing navigation information may also include a third acquisition module 403, a fourth acquisition module 404, and a fourth sending module 405.

The third acquisition module 403 may be configured to obtain a travel request of the first user terminal, wherein the travel request may include a travel start position and the travel end position.

The fourth acquisition module 404 may be configured to obtain, based on the travel start position and the travel end position, a prior navigation route that a fourth user terminal reaches the travel end position from the travel start position.

The fourth sending module 405 may be configured to determine a first navigation road section in the prior navigation route as the current navigation road section, and send navigation information of the first navigation road section in the prior navigation route to the first user terminal.

In some embodiments, the device 400 for sharing navigation information may further include a third acquisition module, a fourth determination module, and a fourth sending module.

The third acquisition module may be configured to obtain a travel request of the first user terminal, wherein the travel request may include a travel start position and the travel end position.

The fourth determination module may be configured to determine, based on the travel start position and the travel end position, an initial navigation route that the first user terminal reaches the travel end position from the travel start position.

The fourth sending module may be configured to determine a first navigation road section in the initial navigation route as the current navigation road section, and send navigation information of the first navigation road section in the initial navigation route to the first user terminal.

In some embodiments, the first sending module 430 may be specifically configured to determine a first target road section in the shared navigation route, wherein a preset count of road sections may be located between the first target road section and the current navigation road section, and determine the first target road section as the next navigation road section that the first user terminal enters.

In some embodiments, the first sending module 430 may be specifically configured to determine a second target road section in the shared navigation route, wherein a spacing distance between the second target road section and the road section end position may be larger than a preset distance threshold, and determine the second target road section as the next navigation road section that the first user terminal enters.

The device for sharing navigation information provided in this embodiment may include determining, based on the road section end position of the current navigation road section and the travel end position of the first user terminal, whether there is a second user terminal that is travelling within the same time period as the first user terminal when the first user terminal is travelling on the current navigation road section, wherein the travel plan of the second user terminal may be from the road section end position to the travel end position. The device may include obtaining the shared navigation route that the second user terminal reaches the travel end position from the road section end position in response to determining that there is a second user terminal that is travelling within the same time period as the first user terminal. The device may further include determining the first navigation road section in the shared navigation route as the next navigation road section which the first user terminal enters after the first user terminal passes through the current navigation road section and sending the navigation information of the first navigation road section in the shared navigation route to the first user terminal.

In this case, in the process of user travel, the navigation route may be obtained by determining different road sections in the entire route of the user travel. Each existing real-time shared navigation route that will enter the road section may be obtained, so as to realize the sharing of the navigation route. Therefore, performing navigation planning repeatedly for different users on the same route in the same time period may be avoided. The computation load for navigation data may be effectively reduced. The occupation and waste of computing resources may be reduced. Further, the convenience and smoothness of travel by the user terminal may be ensured, which is beneficial in improving the experience of the user terminal.

Some embodiments of the present disclosure also provide a computer readable storage medium storing a computer program thereon. When the computer program is executed by a processor, operations of the method for sharing navigation information shown in the above-described FIG. 2 and FIG. 3 may be implemented. The specific embodiments may be referred to the method for sharing navigation information shown in FIG. 2 and FIG. 3, which are not repeated herein.

The above modules may be connected or communicated with each other via a wired connection or a wireless connection. The wired connections may include a metal cable, a cable, a mixed cable, or the like, or any combination thereof. The wireless connection may include a connection in the form of LAN, WAN, Bluetooth, ZigBee, NFC, or the like, or any combination thereof. Two or more modules may be combined into a single module, and any module may be divided into two or more units.

Those skilled in the art will clearly understand that, in order to describe convenient and concise, the specific operation of the system and device described above may be referred to the corresponding process in some embodiments of the method, which are not repeated herein. In several embodiments provided herein, it should be understood that the disclosed system, device, and method may be implemented in other ways. The embodiment of the device described above is merely schematic. For example, the division of the module may be only one logical function division, and there may be additional division modifications when actually implemented. As another example, multiple modules or components may be combined or integrated into another system. Alternatively, some features may be ignored, or not executed. In some embodiments, the coupling, direct coupling, or communication connection between the displayed or discussed components may be through some communication ports. Indirect coupling or communication connection between the devices or modules may be an electrical form, a mechanical form, or other forms.

The modules illustrated as separate components may be or may not be physically separated. The component displayed as a module may be or may not be a physical unit. That is, the components may be located in one place, or may be distributed to a plurality of network units. The suppose of the present disclosure may be implemented by selecting some or all units according to actual requirements.

In addition, each functional unit in some embodiments of the present disclosure may be integrated into one processing unit, or may be generated separately in each unit. Two or more units may be integrated into one unit.

The function may be stored in a non-volatile computer-readable storage medium that can be performed in one processor if the software function unit is implemented as a software functional unit. Based on this understanding, the technical solution of the present disclosure essentially or the contributing to the prior art or the portion of the technical solution may be embodied in the form of software products. The computer software product may store in a storage medium, including several instructions that are used to enable a computer device (which can be a personal computer, a server, a network device, etc.) to perform all or some operations of the method described in some embodiments of the present disclosure. The aforementioned storage medium may include a U disk, a mobile hard disk, a ROM, a RAM, a disk, a medium, etc. that can store program codes.

The above descriptions are merely the specific embodiments of the present disclosure, but the scope of the present disclosure is not limited thereto. Those skilled in the art may easily think of change or replacement within the scope of the present disclosure. The change or replacement should be covered within the protection scope of the present disclosure. Therefore, the protection scope of the present disclosure should be based on the protection scope of the claims.

### INDUSTRIAL PRACTICALITY

The method and device for sharing navigation information provided in the embodiment may obtain the navigation route by dividing different road sections in the entire route of the user travel in the process of user travel. Each existing real-time shared navigation route that is planned for other terminals within a time period may be obtained, so as to realize the sharing of the navigation route. Therefore, performing navigation planning repeatedly for different users on the same route in the same time period may be avoided. The computation load for navigation data may be effectively reduced. The occupation and waste of computing resources may be reduced. Further, the convenience and smoothness of travel by the user terminal may be ensured, which is beneficial in improving the experience of the user terminal.

1. A navigation information sharing method, comprising:
determining, based on a road section end position of a current navigation road section and a travel end position of a first user terminal, whether there is a second user terminal that is travelling within a same time period as the first user terminal when the first user terminal is travelling on the current navigation road section, wherein a travel plan of the second user terminal is from the road section end position to the travel end position;
in response to determining that there is a second user terminal that is travelling within the same time period as the first user terminal, obtaining a shared navigation route that the second user terminal reaches the travel end position from the road section end position;
determining a first navigation road section in the shared navigation route as a next navigation road section which the first user terminal enters after the first user terminal passes through the current navigation road section; and
sending navigation information of the first navigation road section in the shared navigation route to the first user terminal.

2. The method of claim 1, wherein after determining whether there is a second user terminal that is travelling within a same time period as the first user terminal, the method further includes:
in response to determining that there is no second user terminal that is travelling within the same time period as the first user terminal, obtaining a stored historical navigation route from the road section end position to the travel end position based on the road section end position of the current navigation road section and the travel end position of the first user terminal;
detecting whether a first navigation road section in the historical navigation route is in a clear state based on road condition information of the first navigation road section in the historical navigation route;
in response to detecting that the first navigation road section in the historical navigation route is in the clear state, determining the first navigation road section in the historical navigation route as the next navigation road section which the first user terminal enters after the first user terminal passes through the current navigation road section; and
sending navigation information of the first navigation road section in the historical navigation route to the first user terminal.

3. The method of claim 2, wherein after detecting whether a first navigation road section in the historical navigation route is in a clear state based on road condition information of the first navigation road section in the historical navigation route, the method further includes:
in response to detecting that the first navigation road section in the historical navigation route is not in the clear state, determining a predicted navigation route that the first user terminal reaches the travel end position from the road section end position;
determining a first navigation road section in the predicted navigation route as the next navigation road section which the first user terminal enters after the first user terminal passes through the current navigation road section; and
sending navigation information of the first navigation road section in the predicted navigation route to the first user terminal.

4. The method of claim 3, wherein the determining a predicted navigation route that the first user terminal reaches the travel end position from the road section end position includes:
determining a plurality of candidate navigation routes that the first user terminal reaches the travel end position from the road section end position; and
determining the predicted navigation route from the plurality of candidate navigation routes based on road condition information of a first navigation road section in each of the plurality of candidate navigation routes.

5. The method of claim 4, wherein the determining the predicted navigation route from the plurality of candidate navigation routes based on road condition information of a first navigation road section in each of the plurality of candidate navigation routes includes:
selecting a first navigation road section that satisfies a preset passing condition from first navigation road sections corresponding to the plurality of candidate navigation routes based on the road condition information of the first navigation road section in the each of the plurality of candidate navigation routes; and
determining a candidate navigation route including the first navigation road section that satisfies the preset passing condition as the predicted navigation route.

6. The method of claim 5, wherein the preset passing condition includes at least one of:
a minimum passing time;
a shortest passing distance;
a minimum number of signal lights; or
a minimum charge.

7. The method of claim 3, wherein after determining a predicted navigation route that the first user terminal reaches the travel end position from the road section end position in response to detecting that the first navigation road section in the historical navigation route is not in the clear state, the method further includes:
determining whether there is a third user terminal within a preset time range after the predicted navigation route is determined, wherein a travel plan of the third user terminal is from the road section end position to the travel end position; and
in response to determining that there is a third user terminal, sharing the navigation information of the first navigation road section in the predicted navigation route to the third user terminal.

8. The method of claim 1, wherein before determining whether there is a second user terminal that is travelling within a same time period as the first user terminal, the method further includes:
obtaining a travel request of the first user terminal, wherein the travel request includes a travel start position and the travel end position;
obtaining, based on the travel start position and the travel end position, a prior navigation route that a fourth user terminal reaches the travel end position from the travel start position;
determining a first navigation road section in the prior navigation route as the current navigation road section; and
sending navigation information of the first navigation road section in the prior navigation route to the first user terminal.

9. The method of claim 1, wherein before determining whether there is a second user terminal that is travelling within a same time period as the first user terminal, the method further includes:
obtaining a travel request of the first user terminal, wherein the travel request includes a travel start position and the travel end position;
determining, based on the travel start position and the travel end position, an initial navigation route that the first user terminal reaches the travel end position from the travel start position;
determining a first navigation road section in the initial navigation route as the current navigation road section; and
sending navigation information of the first navigation road section in the initial navigation route to the first user terminal.

10. The method of claim 1, wherein the determining a first navigation road section in the shared navigation route as a next navigation road section which the first user terminal enters after the first user terminal passes through the current navigation road section includes:
determining a first target road section in the shared navigation route, wherein a preset count of road sections are located between the first target road section and the current navigation road section; and
determining the first target road section as the next navigation road section that the first user terminal enters.

11. The method of claim 1, wherein the determining a first navigation road section in the shared navigation route as a next navigation road section which the first user terminal enters after the first user terminal passes through the current navigation road section includes:
determining a second target road section in the shared navigation route, wherein a spacing distance between the second target road section and the road section end position is larger than a preset distance threshold; and
determining the second target road section as the next navigation road section that the first user terminal enters.

12-23. (canceled)

24. A non-transitory computer readable storage medium storing instructions, that, when accessed by at least one processor of a system, causes the system to perform a method, the method comprising:
determining, based on a road section end position of a current navigation road section and a travel end position of a first user terminal, whether there is a second user terminal that is travelling within a same time period as the first user terminal when the first user terminal is travelling on the current navigation road section, wherein a travel plan of the second user terminal is from the road section end position to the travel end position;
in response to determining that there is a second user terminal that is travelling within the same time period as the first user terminal, obtaining a shared navigation route that the second user terminal reaches the travel end position from the road section end position;
determining a first navigation road section in the shared navigation route as a next navigation road section which the first user terminal enters after the first user terminal passes through the current navigation road section; and
sending navigation information of the first navigation road section in the shared navigation route to the first user terminal.

25. A device for sharing navigation information, comprising:
at least one storage device storing a set of instructions; and
at least one processor configured to communicate with the at least one storage device, wherein when executing the set of instructions, the at least one processor is directed to perform operations including:
determining, based on a road section end position of a current navigation road section and a travel end position of a first user terminal, whether there is a second user terminal that is travelling within a same time period as the first user terminal when the first user terminal is travelling on the current navigation road section, wherein a travel plan of the second user terminal is from the road section end position to the travel end position;
in response to determining that there is a second user terminal that is travelling within the same time period as the first user terminal, obtaining a shared navigation route that the second user terminal reaches the travel end position from the road section end position;
determining a first navigation road section in the shared navigation route as a next navigation road section which the first user terminal enters after the first user terminal passes through the current navigation road section; and
sending navigation information of the first navigation road section in the shared navigation route to the first user terminal.

26. The device of claim 25, wherein after determining whether there is a second user terminal that is travelling within a same time period as the first user terminal, the method further includes:
in response to determining that there is no second user terminal that is travelling within the same time period as the first user terminal, obtaining a stored historical navigation route from the road section end position to the travel end position based on the road section end position of the current navigation road section and the travel end position of the first user terminal;
detecting whether a first navigation road section in the historical navigation route is in a clear state based on road condition information of the first navigation road section in the historical navigation route;
in response to detecting that the first navigation road section in the historical navigation route is in the clear state, determining the first navigation road section in the historical navigation route as the next navigation road section which the first user terminal enters after the first user terminal passes through the current navigation road section; and
sending navigation information of the first navigation road section in the historical navigation route to the first user terminal.

27. The device of claim 26, wherein after detecting whether a first navigation road section in the historical navigation route is in a clear state based on road condition information of the first navigation road section in the historical navigation route, the method further includes:
in response to detecting that the first navigation road section in the historical navigation route is not in the clear state, determining a predicted navigation route that the first user terminal reaches the travel end position from the road section end position;
determining a first navigation road section in the predicted navigation route as the next navigation road section which the first user terminal enters after the first user terminal passes through the current navigation road section; and
sending navigation information of the first navigation road section in the predicted navigation route to the first user terminal.

28. The device of claim 27, wherein the determining a predicted navigation route that the first user terminal reaches the travel end position from the road section end position includes:
determining a plurality of candidate navigation routes that the first user terminal reaches the travel end position from the road section end position; and
determining the predicted navigation route from the plurality of candidate navigation routes based on road condition information of a first navigation road section in each of the plurality of candidate navigation routes.

29. The device of claim 28, wherein the determining the predicted navigation route from the plurality of candidate navigation routes based on road condition information of a first navigation road section in each of the plurality of candidate navigation routes includes:
selecting a first navigation road section that satisfies a preset passing condition from first navigation road sections corresponding to the plurality of candidate navigation routes based on the road condition information of the first navigation road section in the each of the plurality of candidate navigation routes; and
determining a candidate navigation route including the first navigation road section that satisfies the preset passing condition as the predicted navigation route.

30. The device of claim 29, wherein the preset passing condition includes at least one of:
a minimum passing time;
a shortest passing distance;
a minimum number of signal lights; or
a minimum charge.

31. The device of claim 27, wherein after determining a predicted navigation route that the first user terminal reaches the travel end position from the road section end position in response to detecting that the first navigation road section in the historical navigation route is not in the clear state, the method further includes:
determining whether there is a third user terminal within a preset time range after the predicted navigation route is determined, wherein a travel plan of the third user terminal is from the road section end position to the travel end position; and
in response to determining that there is a third user terminal, sharing the navigation information of the first navigation road section in the predicted navigation route to the third user terminal.

32. The device of claim 25, wherein before determining whether there is a second user terminal that is travelling within a same time period as the first user terminal, the method further includes:
obtaining a travel request of the first user terminal, wherein the travel request includes a travel start position and the travel end position;
obtaining, based on the travel start position and the travel end position, a prior navigation route that a fourth user terminal reaches the travel end position from the travel start position;
determining a first navigation road section in the prior navigation route as the current navigation road section; and
sending navigation information of the first navigation road section in the prior navigation route to the first user terminal.
